(19) United States
(12) Patent Application Publication
(10) Pub. No.: US 2018/0225703 A1
(43) Pub. Date: Aug. 9, 2018

(54) Methods and Systems for Generating Synthetic Content Feeds

(71) Applicant: Facebook, Inc., Menlo Park, CA (US)

(72) Inventors: Bogdan State, La Honda, CA (US); Mui Thu Tran, Truckee, CA (US); Cristele Lartigue, Mountain View, CA (US); Janet Lynn Wiener, Palo Alto, CA (US); Erik Bjorn Vorhes, San Carlos, CA (US)

(21) Appl. No.: 15/425,515

(22) Filed: Feb. 6, 2017

(51) Int. Cl. G06Q 30/02; G06Q 50/00

(52) U.S. Cl. CPC G06Q 30/0242; G06Q 50/01

(57) ABSTRACT

A method of generating a synthetic content feed includes receiving a request to display a synthetic content feed for a class of users of a social networking system, identifying a first user and a second user based on profile data for the first user and second user in the social networking system, constructing a first post of synthetic content feed representative of a first post in the content feed of the first user, constructing a second post of synthetic content feed representative of a second post in the content feed of the second user, and providing the synthetic content feed for display.

### TECHNICAL FIELD

This relates generally to generating synthetic content feeds including but not limited to selecting content for the synthetic content feeds.

### BACKGROUND

Social networking services provide a convenient means for users of the social networking services to share information (e.g., posting an advertisement). Specific user groups may be targeted to view specific information (e.g., an advertisement). However, because of variations in the social-networking feeds of different users, advertisers may not know the context in which their advertisements will be displayed.

### SUMMARY

Accordingly, there is a need for methods and systems for generating a synthetic content feed. Generating a synthetic content feed to view posts for different classes of users can allow advertisers to better test their advertisements and can improve user experiences for viewing advertisements.

In accordance with some embodiments, a method is performed at an electronic device having one or more processors and memory storing instructions for execution by the one or more processors. The method includes receiving a request to display a synthetic content feed for a class of users of a social networking system. Respective users of the class of users have respective content feeds and the synthetic feed is distinct from the respective content feeds of the respective users. The method further includes generating the synthetic content feed by identifying a first user in the class of users and a second user in the class of users based on profile data for the first user and the second user in the social networking system, constructing a first post of the synthetic content feed representative of a first post in the content feed of the first user, and constructing a second post of the synthetic content feed representative of a second post in the content feed of the second user. The method further includes providing the synthetic content feed for display.

In accordance with some embodiments, an electronic device includes one or more processors, memory, and one or more programs. The one or more programs are stored in the memory and configured to be executed by the one or more processors. The one or more programs include instructions for performing the operations of the method described above. In accordance with some embodiments, a non-transitory computer-readable storage medium stores instructions that, when executed by the client device, cause the client device to perform the operations of the method described above.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures and specification.

FIG. 1 is a block diagram illustrating an exemplary network architecture of a social network in accordance with some embodiments.

FIG. 2 is a block diagram illustrating an exemplary server system in accordance with some embodiments.

FIG. 3 is a block diagram illustrating an exemplary client device, in accordance with some embodiments.

FIG. 4 illustrates an exemplary graphical user interface (GUI) of a synthetic content feed for a user of a social networking system on a client device, in accordance with some embodiments.

FIGS. 5A-5E are flow diagrams illustrating a method of generating a synthetic content feed for a user of a social networking system, in accordance with some embodiments.

### DESCRIPTION OF EMBODIMENTS

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are used only to distinguish one element from another. For example, a first post could be termed a second post, and, similarly, a second post could be termed a first post, without departing from the scope of the various described embodiments. The first metric and the second post are both post, but they are not the same post.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

As used herein, the term “exemplary” is used in the sense of “serving as an example, instance, or illustration” and not in the sense of “representing the best of its kind.”

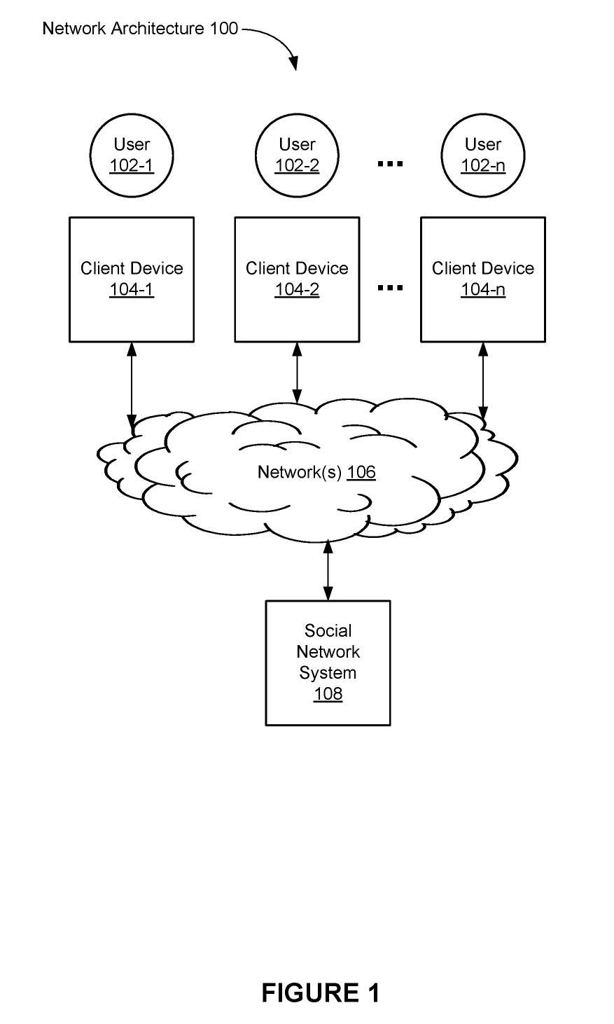

FIG. 1 is a block diagram illustrating an exemplary network architecture of a social network in accordance with some embodiments. The network architecture 100 includes a number of client devices (also called “client systems,” “client computers,” or “clients”) 104-1, 104-2, . . . 104-n communicably connected to a social network system 108 (also referred to herein as a social networking system) by one or more networks 106.

In some embodiments, the client devices 104-1, 104-2, . . . 104-n are computing devices such as smart watches, personal digital assistants, portable media players, smart phones, tablet computers, 2D gaming devices, 3D gaming devices, virtual reality devices, laptop computers, desktop computers, televisions with one or more processors embedded therein or coupled thereto, in-vehicle information systems (e.g., an in-car computer system that provides navigation, entertainment, and/or other information), or other appropriate computing devices that can be used to communicate with an electronic social network system and other computing devices. In some embodiments, the social network system 108 is a single computing device such as a computer server, while in other embodiments, the social network system 108 is implemented by multiple computing devices working together to perform the actions of a server system (e.g., cloud computing). In some embodiments, the network 106 is a public communication network (e.g., the Internet or a cellular data network), a private communications network (e.g., private LAN or leased lines), or a combination of such communication networks.

Users 102-1, 102-2, . . . 102-n employ the client devices 104-1, 104-2, . . . 104-n to access the social network system 108 and to participate in a social networking service. For example, one or more of the client devices 104-1, 104-2, . . . 104-n execute web browser applications that can be used to access the social networking service. As another example, one or more of the client devices 104-1, 104-2, . . . 104-n execute software applications that are specific to the social networking service (e.g., social networking “apps” running on client devices, such as a Facebook social networking application, a messaging application, etc.).

Users interacting with the client devices 104-1, 104-2, . . . 104-n can participate in the social networking service provided by the social network system 108 by providing and/or consuming (e.g., posting, writing, viewing, publishing, broadcasting, promoting, recommending, sharing) information, such as text comments (e.g., statuses, updates, announcements, replies, location “check-ins,” private/group messages), digital content (e.g., photos (i.e., images), videos, audio files, links, documents), and/or other electronic content. In some embodiments, users provide information to a page, group, message board, feed, and/or user profile of a social networking service provided by the social network system 108. Users of the social networking service can also annotate information posted by other users of the social networking service (e.g., endorsing or “liking” a posting of another user, commenting on a posting by another user, or sharing a posting of another user).

In some embodiments, information can be posted on a user's behalf by systems and/or services external to the social network or the social network system 108. For example, the user may post a review of a movie to a movie review website, and with proper permissions that website may cross-post the review to the social network on the user's behalf. In another example, a software application executing on a mobile client device, with proper permissions, may use a global navigation satellite system (GNSS) (e.g., global positioning system (GPS), GLONASS, Galileo, BeiDou, etc.) or other geo-location capabilities (e.g., Wi-Fi or hybrid positioning systems) to determine the user's location and update the social network with the user's location (e.g., “At Home,” “At Work,” or “In San Francisco, Calif.”), and/or update the social network with information derived from and/or based on the user's location. Users interacting with the client devices 104-1, 104-2, . . . 104-n can also use the social network provided by the social network system 108 to define groups of users. Users interacting with the client devices 104-1, 104-2, . . . 104-n can also use the social network provided by the social network system 108 to communicate (e.g., using a messaging application or built-in feature) and collaborate with each other.

In some embodiments, the network architecture 100 also includes third-party servers (not shown). In some embodiments, third-party servers are associated with third-party service providers who provide services and/or features to users of a network (e.g., users of the social network system 108, FIG. 1).

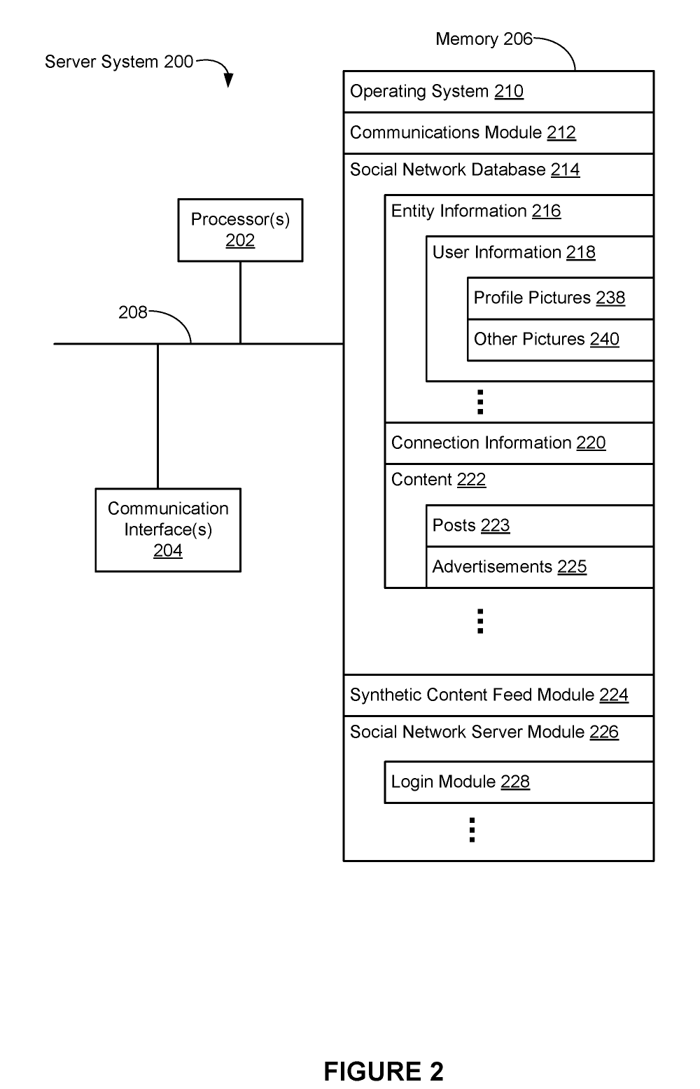

FIG. 2 is a block diagram illustrating an exemplary server system 200 in accordance with some embodiments. In some embodiments, the server system 200 is an example of a social network system 108. The server system 200 typically includes one or more processing units (processors or cores) 202, one or more network or other communications interfaces 204, memory 206, and one or more communication buses 208 for interconnecting these components. The communication buses 208 optionally include circuitry (sometimes called a chipset) that interconnects and controls communications between system components. The server system 200 optionally includes a user interface (not shown). The user interface, if provided, may include a display device and optionally includes inputs such as a keyboard, mouse, trackpad, and/or input buttons. Alternatively or in addition, the display device includes a touch-sensitive surface, in which case the display is a touch-sensitive display.

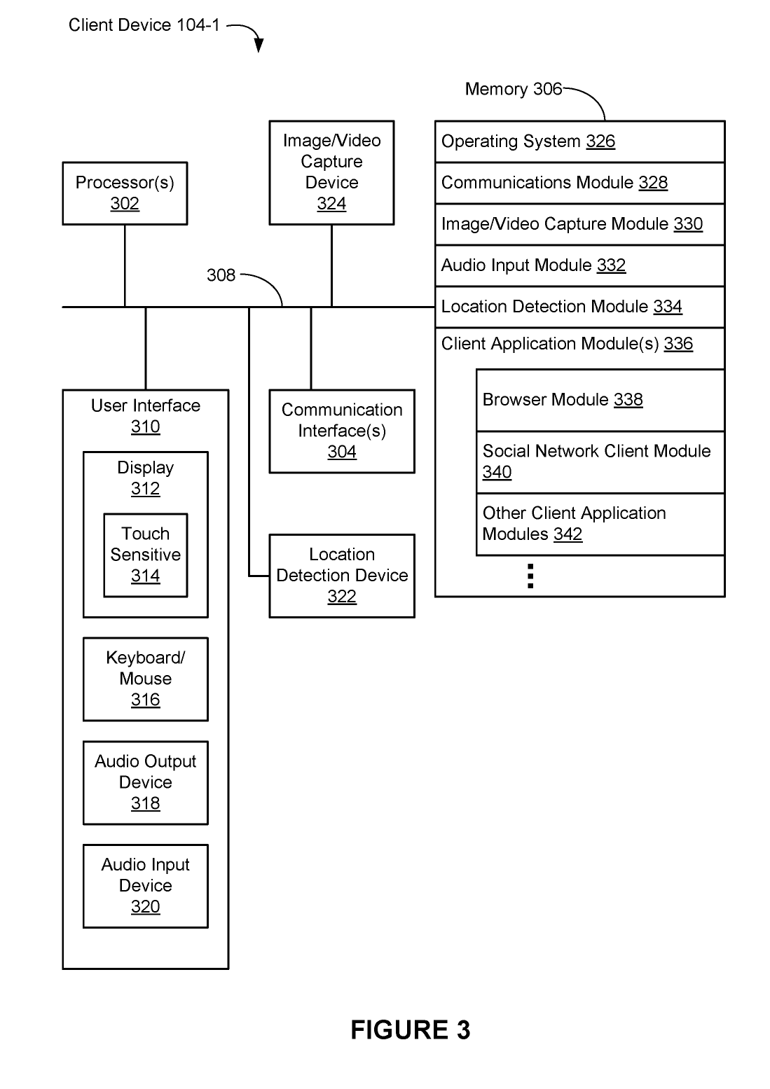

Memory 206 includes high-speed random access memory, such as DRAM, SRAM, DDR RAM, or other random access solid state memory devices; and may include non-volatile memory, such as one or more magnetic disk storage devices, optical disk storage devices, flash memory devices, or other non-volatile solid state storage devices. Memory 206 may optionally include one or more storage devices remotely located from the processor(s) 202. Memory 206, or alternately the non-volatile memory device(s) within memory 206, includes a non-transitory computer readable storage medium. In some embodiments, memory 206 or the computer readable storage medium of memory 206 stores the following programs, modules, and data structures, or a subset or superset thereof:
an operating system 210 that includes procedures for handling various basic system services and for performing hardware-dependent tasks;
a network communication module 212 that is used for connecting server system 200 (e.g., social network system 108, FIG. 1) to other computers (e.g., client devices 104-1, 104-2, . . . 104-n and/or third party servers) via the one or more communication network interfaces 204 (wired or wireless) and one or more communication networks, such as the Internet, cellular telephone networks, mobile data networks, other wide area networks, local area networks, metropolitan area networks, and so on;
a social network database 214 for storing data associated with the social networking service, such as:
   entity information 216, such as user information 218 including profile pictures 238 and other pictures 240;
   connection information 220; and
   user content 222, such as posts 223 and advertisements 225;
synthetic content feed module 224 that generates synthetic content feeds; and
a social network server module 226 for providing social networking services and related features (e.g., in conjunction with social network client module 340 on the client device 104, FIG. 3), which includes:
   a login module 228 for logging in a user into the social network system 108.

The social network database 214 stores data associated with the server system 200 in one or more types of databases, such as graph, dimensional, flat, hierarchical, network, object-oriented, relational, and/or XML databases.

In some embodiments, the social network database 214 includes a graph database, with entity information 216 represented as nodes in the graph database and connection information 220 represented as edges in the graph database. The graph database includes a plurality of nodes, as well as a plurality of edges that define connections between corresponding nodes. In some embodiments, the nodes and/or edges themselves are data objects that include the identifiers, attributes, and information for their corresponding entities, some of which are rendered at clients 104 on corresponding profile pages or other pages in the social networking service. In some embodiments, the nodes also include pointers or references to other objects, data structures, or resources for use in rendering content in conjunction with the rendering of the pages corresponding to the respective nodes at clients 104.

Entity information 216 includes user information 218, such as user profiles, user profile pictures 238, other pictures associated with the user 240 (e.g., images where the user has been tagged or identified by image analysis software), a plurality of icons, login information, payment credentials (e.g., credit-card or debit-card information, bank information, etc. for conducting financial transactions through the social networking service), privacy and other preferences, biographical data, and the like. In some embodiments, for a given user, the user information 218 includes the user's name, profile picture, a plurality of icons, contact information, birth date, sex, marital status, family status, employment, education background, preferences, interests, and/or other demographic information. In some embodiments, the user information may include other information, such as likes and comments, associated with, for example, profile pictures of the user (or other photos of the user).

In some embodiments, entity information 216 includes information about a physical location (e.g., a restaurant, theater, landmark, city, state, or country), real or intellectual property (e.g., a sculpture, painting, movie, game, song, idea/concept, photograph, or written work), a business, a group of people, and/or a group of businesses. In some embodiments, entity information 216 includes information about a resource, such as an audio file, a video file, a digital photo, a text file, a structured document (e.g., web page), or an application. For example, entity information 216 may include a location tag (e.g., Lake Tahoe, Calif., USA) for one or more digital photos. In some embodiments, the resource is located in the social network system 108 (e.g., in content 222) or on an external server, such as a third-party server (not shown).

In some embodiments, connection information 220 includes information about the relationships between entities in the social network database 214. In some embodiments, connection information 220 includes information about edges that connect pairs of nodes in a graph database. In some embodiments, an edge connecting a pair of nodes represents a relationship between the pair of nodes (e.g., also referred to herein as a contact).

In some embodiments, an edge includes or represents one or more data objects or attributes that correspond to the relationship between a pair of nodes. For example, when a first user indicates that a second user is a “friend” of the first user, the social network system 108 transmits a “friend request” to the second user. If the second user confirms the “friend request,” the social network system 108 creates and stores an edge connecting the first user's user node and the second user's user node in a graph database as connection information 220 that indicates that the first user and the second user are friends. In some embodiments, connection information 220 represents a friendship, a family relationship, a business or employment relationship, a fan relationship, a follower relationship, a visitor relationship, a subscriber relationship, a superior/subordinate relationship, a reciprocal relationship, a non-reciprocal relationship, another suitable type of relationship, or two or more such relationships.

In some embodiments, an edge between a user node and another entity node represents connection information 220 about a particular action or activity performed by a user of the user node towards the other entity node. For example, a user may “like” or have “attended,” “played,” “listened,” “cooked,” “worked at,” “watched,” etc. the entity at the other node. The page in the social networking service that corresponds to the entity at the other node may include, for example, a selectable “like,” “check in,” “add to favorites,” etc. icon. After the user clicks one of these icons, the social network system 108 may create a “like” edge, “check in” edge, a “favorites” edge, etc. in response to the corresponding user action. As another example, the user may listen to a particular song using a particular application (e.g., an online music application). In this case, the social network system 108 may create a “listened” edge and a “used” edge between the user node that corresponds to the user and the entity nodes that correspond to the song and the application, respectively, to indicate that the user listened to the song and used the application. In addition, the social network system 108 may create a “played” edge between the entity nodes that correspond to the song and the application to indicate that the particular song was played by the particular application.

In some embodiments, content 222 includes text (e.g., ASCII, SGML, HTML), images (e.g., jpeg, tif and gif), graphics (e.g., vector-based or bitmap), audio, video (e.g., mpeg), other multimedia, and/or combinations thereof. In some embodiments, content 222 includes executable code (e.g., script for API calls), podcasts, links, and the like. In some embodiments content 222 contains posts 223 (e.g., social media posts) and advertisements 225.

FIG. 3 is a block diagram illustrating an exemplary client device 300, in accordance with some embodiments. The client device 300 is an example of the one or more client devices 104-1, 104-2, . . . 104-n (FIG. 1). The client device 300 typically includes one or more processing units (processors or cores) 302, one or more network or other communications interfaces 304, memory 306, and one or more communication buses 308 for interconnecting these components. The communication buses 308 optionally include circuitry (sometimes called a chipset) that interconnects and controls communications between system components. The client device 300 includes a user interface 310. The user interface 310 typically includes a display device 312. In some embodiments, the client device 300 includes inputs such as a keyboard, mouse, and/or other input buttons 316. Alternatively or in addition, in some embodiments, the display device 312 includes a touch-sensitive surface 314, in which case the display device 312 is a touch-sensitive display. In some embodiments, the touch-sensitive surface 314 is configured to detect various swipe gestures (e.g., continuous gestures in vertical and/or horizontal directions) and/or other gestures (e.g., single/double tap). In client devices that have a touch-sensitive display 312, a physical keyboard is optional (e.g., a soft keyboard may be displayed when keyboard entry is needed). The user interface 310 also includes an audio output device 318, such as speakers or an audio output connection connected to speakers, earphones, or headphones. Furthermore, some client devices 300 use a microphone and voice recognition to supplement or replace the keyboard. Optionally, the client device 300 includes an audio input device 320 (e.g., a microphone) to capture audio (e.g., speech from a user). Optionally, the client device 300 includes a location detection device 322, such as a GNSS (e.g., GPS, GLONASS, Galileo, BeiDou, etc.) or other geo-location receiver, for determining the location of the client device 300. The client device 300 also optionally includes an image/video capture device 324, such as a camera and/or a webcam.

In some embodiments, the client device 300 includes one or more optional sensors (e.g., gyroscope, accelerometer) for detecting motion and/or a change in orientation of the client device. In some embodiments, the detected motion and/or orientation of the client device 300 (e.g., the motion/change in orientation corresponding to a user input produced by a user of the client device) is used to manipulate an interface (or content within the interface) displayed on the client device 300. In some embodiments, the one or more optional sensors may include an optical projection sensor for projecting an interface displayed on the client device 300 in 3D (e.g., project 3D hologram). Moreover, a user may manipulate the interface displayed on the client device 300 by interacting with the projected holographic 3D display.

Memory 306 includes high-speed random-access memory, such as DRAM, SRAM, DDR RAM, or other random-access solid-state memory devices; and may include non-volatile memory, such as one or more magnetic disk storage devices, optical disk storage devices, flash memory devices, or other non-volatile solid-state storage devices. Memory 306 may optionally include one or more storage devices remotely located from the processor(s) 302. Memory 306, or alternately the non-volatile memory device(s) within memory 306, includes a non-transitory computer-readable storage medium. In some embodiments, memory 306 or the computer-readable storage medium of memory 306 stores the following programs, modules, and data structures, or a subset or superset thereof:
an operating system 326 that includes procedures for handling various basic system services and for performing hardware-dependent tasks;
a network communication module 328 that is used for connecting the client device 104 to other computers via the one or more communication network interfaces 304 (wired or wireless) and one or more communication networks, such as the Internet, cellular telephone networks, mobile data networks, other wide area networks, local area networks, metropolitan area networks, and so on;
an image/video capture module 330 (e.g., a camera module) for processing a respective image or video captured by the image/video capture device 324, where the respective image or video may be sent or streamed (e.g., by a client application module 336) to the social network system 108;
an audio input module 332 (e.g., a microphone module) for processing audio captured by the audio input device 320, where the respective audio may be sent or streamed (e.g., by a client application module 336) to the social network system 108;
a location detection module 334 (e.g., a GPS, Wi-Fi, or hybrid positioning module) for determining the location of the client device 104 (e.g., using the location detection device 322) and providing this location information for use in various applications (e.g., social network client module 340); and
one or more client application modules 336, including the following modules (or sets of instructions), or a subset or superset thereof:
   a web browser module 338 (e.g., Internet Explorer or Edge by Microsoft, Firefox by Mozilla, Safari by Apple, or Chrome by Google) for accessing, viewing, and interacting with web sites;
   a social network module 340 for providing an interface to a social networking service (e.g., a social networking service provided by social network system 108) and related features, and for loading (e.g., within the interface for the social network module 340) pages associated with third-party service providers (e.g., to conduct transactions with the third-party service providers); and/or
   optional client application modules 342, such as applications for word processing, calendaring, mapping, weather, stocks, time keeping, virtual digital assistant, presenting, number crunching (spreadsheets), drawing, instant messaging, e-mail, telephony, video conferencing, photo management, video management, a digital music player, a digital video player, 2D gaming, 3D gaming, virtual reality, electronic book reader, and/or workout support.

In some embodiments, the location detection module 334 may attach a location to an image captured by the client device 300. For example, if a user 102 of the client device 300 captures an image while in a location (e.g., San Francisco, Calif.), the client device 300 will attach the location to the captured image (e.g., San Francisco, Calif., will be attached).

Each of the above identified modules and applications correspond to a set of executable instructions for performing one or more functions as described above and/or in the methods described in this application (e.g., the computer-implemented methods and other information processing methods described herein). These modules (i.e., sets of instructions) need not be implemented as separate software programs, procedures or modules, and thus various subsets of these modules are, optionally, combined or otherwise re-arranged in various embodiments. In some embodiments, memory 206 and/or 306 store a subset of the modules and data structures identified above. Furthermore, memory 206 and/or 306 optionally store additional modules and data structures not described above.

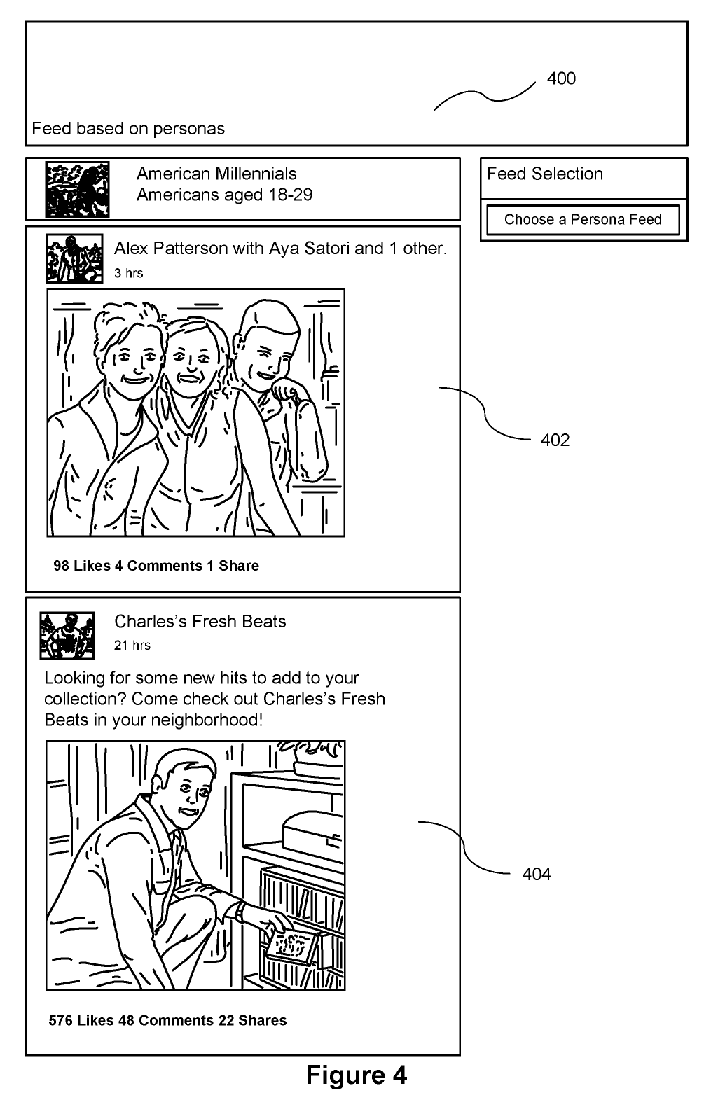

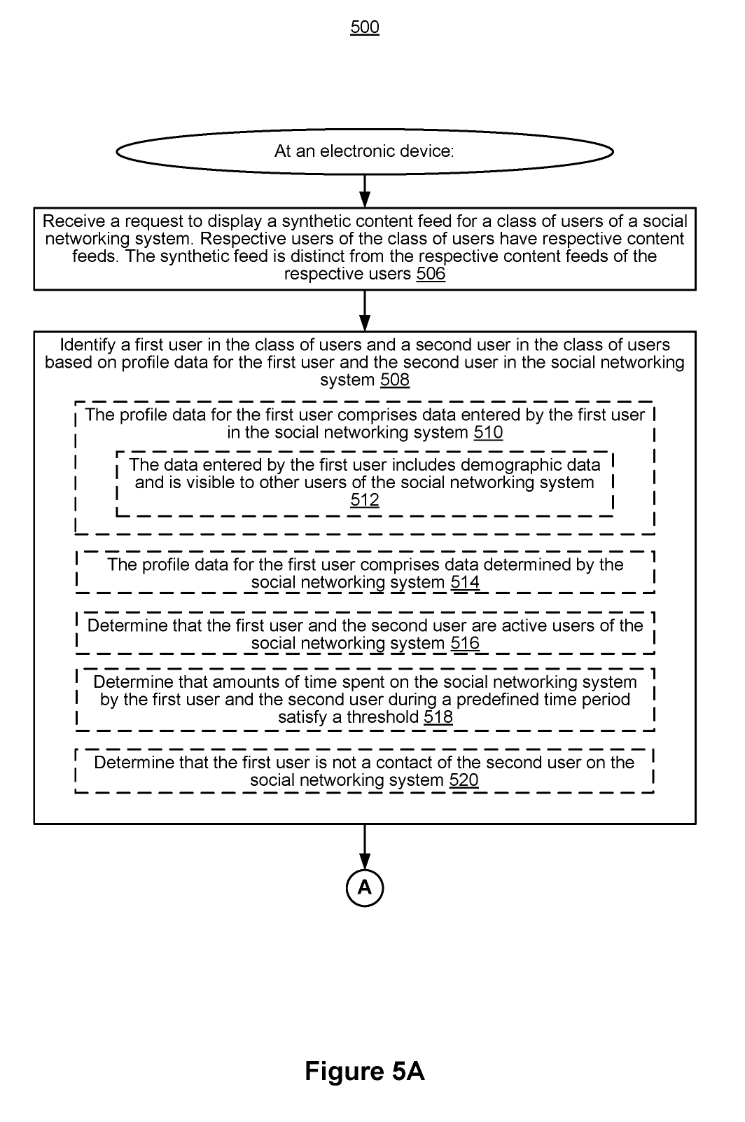

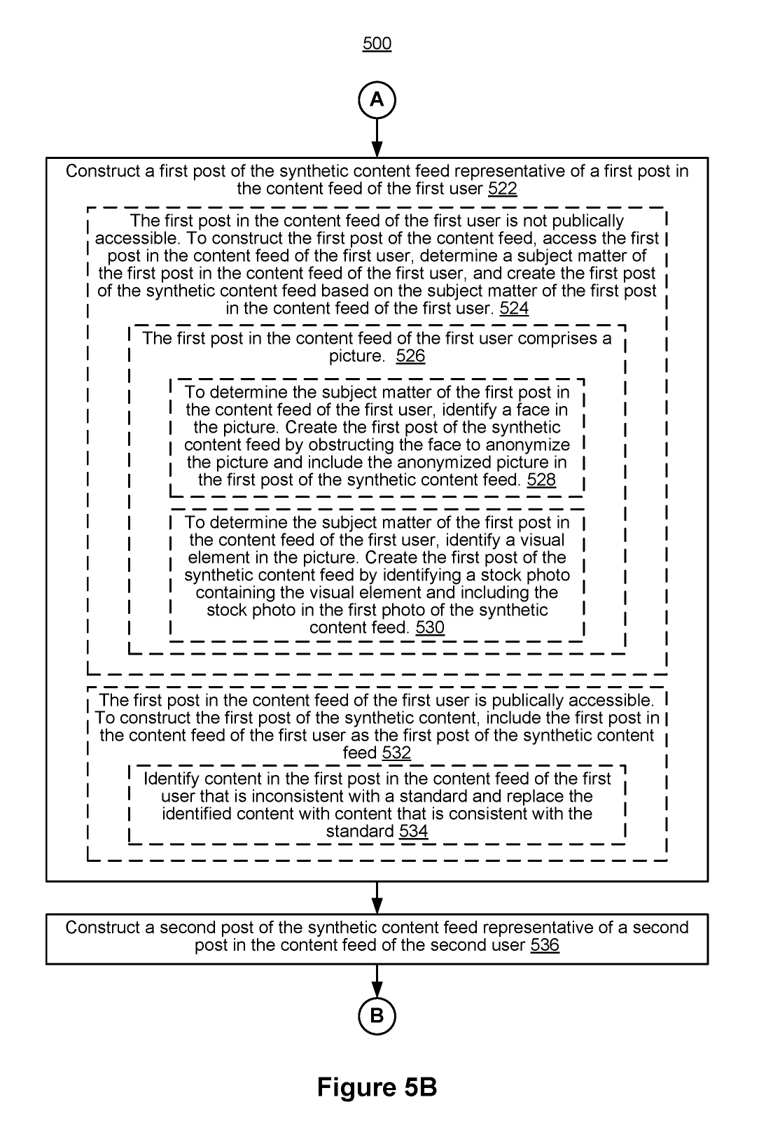

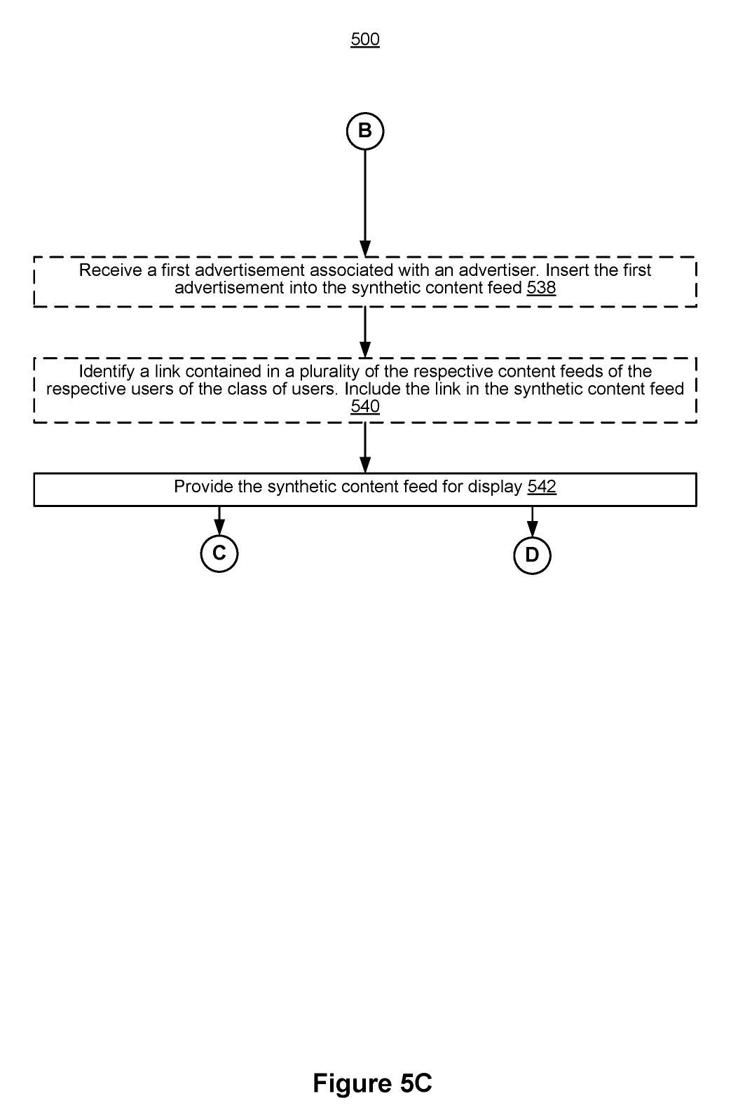

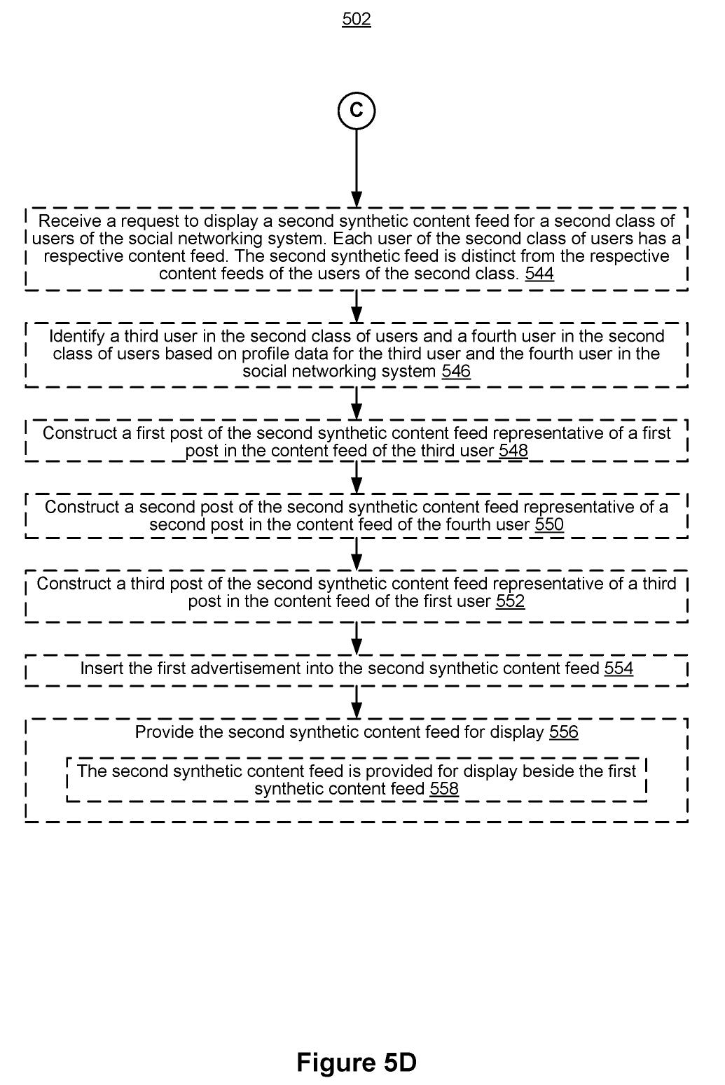

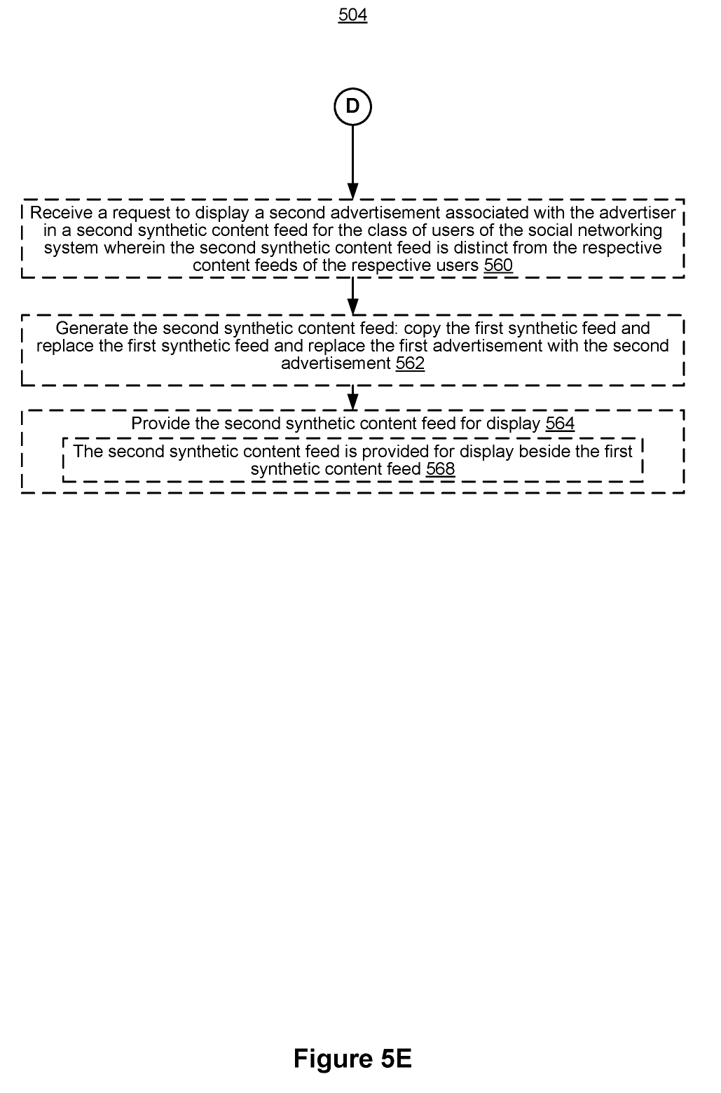

FIG. 4 illustrates an exemplary graphical user interface (GUI) of a synthetic content feed for a user of a social networking system on an electronic device, in accordance with some embodiments. FIG. 4 is discussed below in conjunction with FIGS. 5A-5E.

FIGS. 5A-5E are flow diagrams illustrating methods 500 (FIGS. 5A-5C), 502 (FIG. 5D), and 504 (FIG. 5E) of generating a synthetic content feed for a class of users of a social networking system in accordance with some embodiments. The methods 502 and/or 504 may be performed in conjunction with the method 500.

The methods 500, 502, and/or 504 are performed by an electronic device. For example, the methods 500, 502, and/or 504 may be performed by the social network system 108 (FIG. 1) (e.g., a server system 200, FIG. 2). Alternatively, the methods 500, 502, and/or 504 may be performed by a client device 104 (FIGS. 1, 3). The methods 500, 502, and 504 correspond to instructions stored in a computer memory or computer readable storage medium (e.g., memory 206 of the server system 200; memory 306 of the client device 300). For example, the operations of method 500 are performed, at least in part, by the synthetic content feed module 224 and/or the social network server module 226 ( ) or by a client application module 336 (FIG. 3).

In performing the method 500, the electronic device receives 506 a request to display a synthetic content feed for a class of users of a social networking system. Respective users of the class of users have respective content feeds. The synthetic content feed is distinct from the respective content feeds of the respective users. The synthetic content feed is considered synthetic because it is not a content feed for an actual user.

The electronic device generates the synthetic content feed. The synthetic content feed may be generated after the request is received (e.g., in response to the request), as shown in FIG. 5A, or before the request is received.

To generate the synthetic content feed identifies 508 a first user in the class of users and a second user in the class of users based on profile data for the first user and the second user in the social networking system. In some embodiments, the profile data 510 for the first user (and/or second user) comprises data entered by the first user (and/or second user) in the social networking system. In some embodiments, the data entered 512 by the first user (and/or second user) includes demographic data and is visible to other users of the social networking system. Additional users in the class of users may be similarly identified based on their profile data.

In some embodiments, the profile data 514 for the first user (and/or the second user and additional identified users) comprises data determined by the social networking system, as opposed to data provided by the user. In some embodiments, the electronic device determines 516 that the first user and the second user are active users of the social networking system. For example, the social networking system may select users who on average spend an hour or more online each day.

In some embodiments, the electronic device determines 518 that amounts of time spent on the social networking system by the first user and the second user during a predefined time-period satisfy (e.g., exceed, or equal or exceed) a threshold (e.g., 1 hour each day). For example, a synthetic content feed can be generated using posts of users who are heavy users of the social networking system.

In some embodiments, the electronic device determines 520 that the first user is not a contact (e.g., “friend”) of the second user on the social networking system. Identifying users who are not contacts helps to ensure that the synthetic feed reflects diversity within the class of users.

The electronic device constructs 522 (FIG. 5B) a first post of the synthetic content feed representative of a first post in the content feed of the first user. In some embodiments the first post in the content feed of the first user is not publically accessible (e.g., private link, private photo). To construct the first post of the content feed, the first post in the content feed of the first user is accessed 524. A subject matter of the first post in the content feed of the first user is determined and the first post of the synthetic content feed is created based on the subject matter of the first post in the content feed of the first user. For example, post 402 of the synthetic content feed 400 (FIG. 4) contains subject matter included in the first post in the content feed of the first user and has been used to create the first post of the synthetic content feed.

In some embodiments the first post 526 in the content feed of the first user comprises a picture (e.g., a photograph). To determine the subject matter of the first post in the content feed of the first user, a face in the picture is identified 528. The first post of the synthetic content feed is created by obstructing the face (or multiple identified faces) to anonymize the picture (e.g., by blurring the face, cropping the face out of the photo, etc.) and by including the anonymized picture in the first post of the synthetic content feed. In some embodiments, to determine the subject matter of the first post in the content feed of the first user, a visual element in the picture is identified 530. The first post of the synthetic content feed is created by identifying a stock photo (e.g., as stored in the social network database 214, FIG. 2, or in a database of photos) containing the visual element and including the stock photo in the first photo of the synthetic content feed.

In some embodiments, the first post 532 in the content feed of the first user is publically accessible. The first post in the content feed of the first user is included as the first post of the synthetic content feed. In some embodiments the content of the first post in the content feed of the first user that is inconsistent with a standard is identified 534 and the identified content is replaced with content that is consistent with the standard. For example a post in the content feed of the user may contain inappropriate content. The inappropriate content will be replaced with appropriate content before being constructed into the synthetic content feed.

In some embodiments, the electronic device constructs 536 a second post of the synthetic content feed representative of a second post in the content feed of the second user. The second post of the synthetic content feed may be constructed in a similar manner to the first post of the synthetic content feed (e.g., in accordance with one or more of the steps 524, 526, 528, 530, 532, and 534). For example, the second post 404 in the synthetic content feed 400 (FIG. 4) is a second post in the content feed of the second user. Additional posts may be constructed that are representative of posts in the content feeds of additional identified users.

In some embodiments, the electronic device receives 538 (FIG. 5C) a first advertisement associated with an advertiser and inserts the first advertisement into the synthetic content feed. The first advertisement may be inserted between the first and second posts of the synthetic content feed, before the first and second posts of the synthetic content feed, or after the first and second posts of the synthetic content feed. For example, post 404 is an advertisement that is inserted into the synthetic content feed 400 (FIG. 4) to preview the advertisement before publication. The request of step 506 thus may come from the advertiser.

In some embodiments, the electronic device identifies 540 a link contained in a plurality of the respective content feeds of the respective users of the class of users and includes the link in the synthetic content feed. The presence of the link in multiple content feeds for the class of users indicates that the link is popular within the class of users and thus appropriate for inclusion in the synthetic content feed.

In some embodiments, the electronic device provides 542 the synthetic content feed for display. FIG. 4 shows a synthetic content feed 400 displayed on an electronic device 104-1. If a server system 200 (FIG. 2) performs the method 500, the server system 200 may provide the synthetic content feed by transmitting it to a client device 104 for display. If a client device 104 (FIGS. 1, 3) performs the method 500, the client device 104 may provide the synthetic content feed to its display 312 for display.

In performing the method 502 (FIG. 5D), a request to display a second synthetic content feed for a second class of users of the social networking system is received 544. (The synthetic content feed of the method 500 is the first synthetic content feed.) Each user of the second class of users has a respective content feed. The second synthetic feed is distinct from the respective content feeds of the users of the second class.

The electronic device generates the second synthetic content feed. The second synthetic content feed may be generated after the request is received (e.g., in response to the request), as shown in FIG. 5C, or before the request is received.

To generate the second synthetic content feed, the electronic device identifies 546 a third user in the second class of users and a fourth user in the second class of users based on profile data for the third user and the fourth user in the social networking system. This identification may be performed as in steps 508, 510, 512, 514, 516, 518, and/or 520 (FIG. 5A). Additional users in the second class may also be identified.

The electronic device constructs 548 a first post of the second synthetic content feed representative of a first post in the content feed of the third user and constructs 550 a second post of the second synthetic content feed representative of a second post in the content feed of the fourth user. In some embodiments the electronic device constructs 552 a third post of the second synthetic content feed representative of a third post in the content feed of the first user and may construct additional posts that are representative of additional identified users. Posts may be constructed as in steps 522, 524, 526, 528, 530, 532, and/or 534 (FIG. 5B).

In some embodiments, the electronic device inserts 554 the first advertisement into the second synthetic content feed (e.g., in a similar manner as in step 538, FIG. 5C).

In some embodiments, the electronic device provides 556 the second synthetic content feed for display (e.g., in a similar manner as in step 542, FIG. 5C). In some embodiments the second synthetic content feed is provided 558 for display beside the first synthetic content feed.

In performing the method 504 (FIG. 5E), the electronic device receives 560 a request to display a second advertisement associated with the advertiser in a second synthetic content feed for the class of users of the social networking system. The second synthetic content feed is distinct from the respective content feeds of the respective users.

In some embodiments, the electronic device copies 562 the first synthetic feed and replaces the first synthetic feed and the first advertisement with the second advertisement.

The electronic device provides 564 the second synthetic content feed for display. In some embodiments, the second synthetic content feed is provided 568 for display beside the first synthetic content feed, for comparison.

Although some of various drawings illustrate a number of logical stages in a particular order, stages which are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

What is claimed is:

1. A method, comprising:
at an electronic device having one or more processors and memory storing instructions for execution by the one or more processors:
receiving a request to display a synthetic content feed for a class of users of a social networking system, wherein respective users of the class of users have respective content feeds and the synthetic feed is distinct from the respective content feeds of the respective users;
generating the synthetic content feed, the generating comprising:
identifying a first user in the class of users and a second user in the class of users based on profile data for the first user and the second user in the social networking system;
constructing a first post of the synthetic content feed representative of a first post in the content feed of the first user; and
constructing a second post of the synthetic content feed representative of a second post in the content feed of the second user; and
providing the synthetic content feed for display.

2. The method of claim 1, wherein the profile data for the first user comprises data entered by the first user in the social networking system.

3. The method of claim 2, wherein the data entered by the first user includes demographic data and is visible to other users of the social networking system.

4. The method of claim 1, wherein the profile data for the first user comprises data determined by the social networking system.

5. The method of claim 1, wherein:
the first post in the content feed of the first user is not publically accessible; and
constructing the first post of the synthetic content feed comprises:
accessing the first post in the content feed of the first user;
determining a subject matter of the first post in the content feed of the first user; and
creating the first post of the synthetic content feed based on the subject matter of the first post in the content feed of the first user.

6. The method of claim 5, wherein:
the first post in the content feed of the first user comprises a picture;
determining the subject matter of the first post in the content feed of the first user comprises identifying a visual element in the picture; and
creating the first post of the synthetic content feed comprises:
identifying a stock photo containing the visual element; and
including the stock photo in the first post of the synthetic content feed.

7. The method of claim 5, wherein:
the first post in the content feed of the first user comprises a picture;
determining the subject matter of the first post in the content feed of the first user comprises identifying a face in the picture; and
creating the first post comprises:
obstructing the face to anonymize the picture; and
including the anonymized picture in the first post of the synthetic content feed.

8. The method of claim 1, wherein identifying the first user and the second user comprises determining that the first user and the second user are active users of the social networking system.

9. The method of claim 1, wherein identifying the first user and the second user comprises determining that amounts of time spent on the social networking system by the first user and the second user during a predefined time period satisfy a threshold.

10. The method of claim 1, further comprising, at the electronic device:
receiving a first advertisement associated with an advertiser; and
inserting the first advertisement into the synthetic content feed.

11. The method of claim 10, wherein the synthetic content feed is a first synthetic content feed, the method further comprising, at the electronic device:
receiving a request to display a second advertisement associated with the advertiser in a second synthetic content feed for the class of users of the social networking system, wherein the second synthetic content feed is distinct from the respective content feeds of the respective users;
generating the second synthetic content feed, comprising copying the first synthetic feed and replacing the first advertisement with the second advertisement; and
providing the second synthetic content feed for display.

12. The method of claim 11, wherein the second synthetic content feed is provided for display beside the first synthetic content feed.

13. The method of claim 10, wherein the class of users is a first class of users, the method further comprising, at the electronic device:
receiving a request to display a second synthetic content feed for a second class of users of the social networking system, wherein each user of the second class of users has a respective content feed and the second synthetic feed is distinct from the respective content feeds of the users of the second class;
generating the second synthetic content feed, the generating comprising:
identifying a third user in the second class of users and a fourth user in the second class of users based on profile data for the third user and the fourth user in the social networking system;
constructing a first post of the second synthetic content feed representative of a first post in the content feed of the third user;
constructing a second post of the second synthetic content feed representative of a second post in the content feed of the fourth user; and
inserting the first advertisement into the second synthetic content feed; and
providing the second synthetic content feed for display.

14. The method of claim 1, wherein:
the first post in the content feed of the first user is publically accessible; and
constructing the first post of the synthetic content feed comprises including the first post in the content feed of the first user as the first post of the synthetic content feed.

15. The method of claim 14, wherein constructing the first post of the synthetic content feed further comprises:
identifying content in the first post in the content feed of the first user that is inconsistent with a standard; and
replacing the identified content with content that is consistent with the standard.

16. The method of claim 1, wherein identifying the first user and the second user comprises determining that the first user is not a contact of the second user on the social networking system.

17. The method of claim 1, wherein generating the synthetic content feed further comprises constructing a third post of the synthetic content feed representative of a third post in the content feed of the first user.

18. The method of claim 1, wherein generating the synthetic content feed further comprises:
identifying a link contained in a plurality of the respective content feeds of the respective users of the class of users; and
including the link in the synthetic content feed.

19. An electronic device, comprising:
one or more processors; and
memory storing one or more programs for execution by the one or more processors, the one or more programs including instructions for:
receiving a request to display a synthetic content feed for a class of users of a social networking system, wherein respective users of the class of users have respective content feeds and the synthetic feed is distinct from the respective content feeds of the respective users;
generating the synthetic content feed, the generating comprising:
identifying a first user in the class of users and a second user in the class of users based on profile data for the first user and the second user in the social networking system;
constructing a first post of the synthetic content feed representative of a first post in the content feed of the first user; and
constructing a second post of the synthetic content feed representative of a second post in the content feed of the second user; and
providing the synthetic content feed for display.

20. A non-transitory computer-readable storage medium storing one or more programs for execution by one or more processors of an electronic device, the one or more programs including instructions for:
receiving a request to display a synthetic content feed for a class of users of a social networking system, wherein respective users of the class of users have respective content feeds and the synthetic feed is distinct from the respective content feeds of the respective users;
generating the synthetic content feed, the generating comprising:
identifying a first user in the class of users and a second user in the class of users based on profile data for the first user and the second user in the social networking system;
constructing a first post of the synthetic content feed representative of a first post in the content feed of the first user; and
constructing a second post of the synthetic content feed representative of a second post in the content feed of the second user; and
providing the synthetic content feed for display.
